(19) United States
(12) Patent Application Publication
(10) Pub. No.: US 2024/0211201 A1
(43) Pub. Date: Jun. 27, 2024

(54) ACOUSTIC DEVICE, ACOUSTIC DEVICE CONTROL METHOD, AND PROGRAM

(71) Applicant: AlphaTheta Corporation, Yokohama-shi, Kanagawa (JP)

(72) Inventor: Minoru Watanabe, Yokohama-shi, Kanagawa (JP)

(21) Appl. No.: 18/557,330

(22) PCT Filed: Apr. 30, 2021
(86) PCT No.: PCT/JP2021/017187

§ 371 Date: Oct. 26, 2023

(51) Int. Cl. G06F 3/16

(52) U.S. Cl. CPC G06F 3/165

(57) ABSTRACT

An acoustic device includes: a cross fader for adjusting a sound volume balance between a first music piece played through a first channel and a second music piece played through a second channel; a setting unit for setting a mixing curve for a plurality of parts of the first and second music pieces in accordance with a position of the cross fader; and a playback controller for controlling the sound volume balance of each of the plurality of parts in accordance with the mixing curve.

### TECHNICAL FIELD

The present invention relates to an acoustic device, a control method of the acoustic device, and a program.

### BACKGROUND ART

Typical DJ instruments (e.g. DJ controllers), which each include a plurality of decks, are configured to switch the currently played music piece to another music piece by switching sound outputs of the decks while playing music with the plurality of decks. In order to switch the music pieces by the DJ instruments, a cross fader, which is configured to adjust sound volumes of the plurality of decks provided on the DJ instruments, is used. However, the cross fader requires a skillful operation by a user for natural switching operation.

Thus, various techniques for supporting the music switching operation have been proposed. For instance, an acoustic device disclosed in Patent Literature 1 adjusts an output level, focusing on a frequency range, thereby preventing occurrence of uncomfortable impression when the music pieces are mixed.

### CITATION LIST

### Patent Literature(s)

Patent Literature 1: JP Patent No. 6171503

### SUMMARY OF THE INVENTION

### Problem(s) to be Solved by the Invention

When the music pieces are switched as described above, operations such as an operation for adjusting tempos of the music pieces before and after the switching operation, an operation for applying various effects on the currently played music piece, a cue operation for selecting a play start position of the next played music, and an operation for switching the music pieces with the cross fader have to be precisely performed to the rhythm of the music pieces. Since such a series of operations require knowledge and experience on music, it is difficult for a user who has insufficient knowledge and experience of that kind to enjoy a DJ play that accompanies the switching operation of the music pieces.

An object of the invention is to provide an acoustic device, a control method of the acoustic device, and a program, which allow a user with insufficient knowledge and experience on music to easily perform a suitable switching operation in switching music pieces.

### Means for Solving the Problem(s)

[1] An acoustic device includes: a cross fader configured to adjust a sound volume balance between a first music piece played through a first channel and a second music piece played through a second channel; a setting unit configured to set a mixing curve on each of a plurality of parts of the first music piece and the second music piece in accordance with a position of the cross fader; and a playback controller configured to control the sound volume balance of each of the plurality of parts in accordance with the mixing curve.
[2] In the acoustic device according to [1], the plurality of parts of the first music piece and the second music piece include sub-parts subdivided therefrom.
[3] In the acoustic device according to [1] or [2], the plurality of parts at least include a sub-part corresponding to a bass drum sound of a drum sound.
[4] In the acoustic device according to any one of [1] to [3], the setting unit is configured to set a first mixing curve on a first part of the plurality of parts and set a second mixing curve different from the first mixing curve on a second part different from the first part.
[5] In the acoustic device according to [4], the first mixing curve is a curve whose sound volume balance gradually changes and the second mixing curve is a curve whose sound volume balance sharply changes.
[6] In the acoustic device according to [4], the first mixing curve or the second mixing curve is a curve showing that a sound volume of one of the first and second music pieces gradually changes and a sound volume of the other of the first and second music pieces sharply changes.
[7] A control method of an acoustic device including a cross fader configured to adjust a sound volume balance between a first music piece played through a first channel and a second music piece played through a second channel, the method includes: setting a mixing curve on each of a plurality of parts of the first music piece and the second music piece in accordance with a position of the cross fader; and controlling the sound volume balance of each of the plurality of parts in accordance with the mixing curve.
[8] A program causing a computer to operate as an acoustic device, the acoustic device including: a cross fader configured to adjust a sound volume balance between a first music piece played through a first channel and a second music piece played through a second channel; a setting unit configured to set a mixing curve on each of a plurality of parts of the first music piece and the second music piece in accordance with a position of the cross fader; and a playback controller configured to control the sound volume balance of each of the plurality of parts in accordance with the mixing curve.

According to the arrangements described above, the acoustic device, which includes the cross fader for adjusting the sound volume balance between the first music piece played through the first channel and the second music piece played through the second channel, sets the mixing curve for a plurality of parts of the first and the second music pieces in accordance with the position of the cross fader and control the sound volume balance of each of the plurality of parts in accordance with the set mixing curve. Accordingly, even a user with insufficient knowledge and experience on music can easily perform a suitable switching operation in switching the music pieces.

### BRIEF DESCRIPTION OF THE DRAWINGS

FIG. 1 is an illustration schematically depicting an acoustic device according to a first exemplary embodiment of the invention.

FIG. 2A illustrates an example of a mixing curve.

FIG. 2B illustrates another example of the mixing curve.

FIG. 3 is a block diagram illustrating an overall functional arrangement of the acoustic device according to the first exemplary embodiment of the invention.

FIG. 4 is an illustration schematically showing a switching process of music pieces according to the first exemplary embodiment of the invention.

FIG. 5 is another illustration schematically showing the switching process of music pieces according to the first exemplary embodiment of the invention.

FIG. 6 is a flowchart showing a control method of the acoustic device according to the first exemplary embodiment of the invention.

FIG. 7 is a block diagram illustrating an overall functional arrangement of an acoustic device according to a second exemplary embodiment of the invention.

FIG. 8 is a flowchart showing a control method of the acoustic device according to the second exemplary embodiment of the invention.

### DESCRIPTION OF EMBODIMENT(S)

Some exemplary embodiments of the invention will be described in detail below with reference to the attached drawings. It should be noted that components of the same or substantially the same function(s) and structure(s) will be denoted by the same reference numerals in the specification and drawings, omitting repetition of description thereof.

### First Exemplary Embodiment

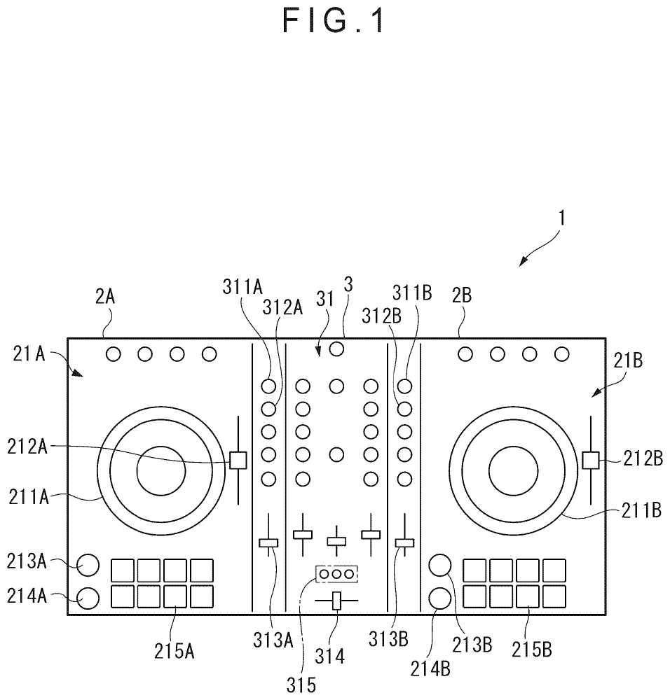

FIG. 1 is an illustration schematically depicting an acoustic device according to a first exemplary embodiment.

An acoustic device 1 according to the present exemplary embodiment is a DJ system including two media players 2A and 2B, which are each configured to play a music piece, and a mixer 3 configured to control the media players 2A and 2B, the media players 2A and 2B and the mixer 3 being integrated to form a unitary system. Specifically, the acoustic device 1, which serves as a sound playback device and a sound playback control device in response to an operation by a user, is configured to play the music piece and apply various effects on currently played music piece. Examples of the effects include effects for outputting an effected sound by applying an effect (e.g. delay, echo, reverb, or loop) on a music piece and effects for outputting a processed sound by processing an original sound.

As shown in FIG. 1, the acoustic device 1 includes operation units 21A and 21B respectively provided on the media players 2A and 2B, and an operation unit 31 provided on the mixer 3.

The operation unit 21A and the operation unit 21B are configured to receive user's operations on the media player 2A and the media player 2B, respectively. The operation unit 31 is configured to receive a user's operation on the mixer 3.

The operation unit 21A includes a jog dial 211A, a tempo slider 212A, a cue button 213A, a play/pause button 214A, and a performance pad 215A.

More specifically, the jog dial 211A is a rotary operator and is used for setting a playback direction and playback speed of the music piece currently played by the media player 2A. The tempo slider 212A is configured to adjust the playback speed of the music piece currently played by the media player 2A. The cue button 213A is pressed down for setting a predetermined point of the music piece as a cue point. The play/pause button 214A is pressed down for starting or stopping playing the music piece with the media player 2A. The performance pad 215A is a versatile operator capable of being assigned with various functions relating to the playback control.

The operation unit 21B includes, as with the operation unit 21A, a jog dial 211B, a tempo slider 212B, a cue button 213B, a play/pause button 214B, and a performance pad 215B.

The acoustic device 1 is configured to, for instance, in response to a user's operation on the operation unit 21A of the media player 2A, play the music piece loaded to the media player 2A and apply an effect(s) on the music piece being played as necessary. The same applies to the media player 2B.

The mixer 3 is configured to, in accordance with a user's operation, switch the music pieces between those being played by the media players 2A and 2B, adjust a sound volume of each of the channels, and apply the effect(s) on the music piece(s) being played.

The operation unit 31 of the mixer 3 includes effect selector knobs 311A and 311B, effect amount adjuster knobs 312A and 312B, channel faders 313A and 313B, a cross fader 314, and mixing curve adjuster knobs 315.

More specifically, the effect selector knobs 311A and 311B are used in order to select the effect(s) to be applied on the music piece being played by the media players 2A and 2B, respectively. The effect amount adjuster knobs 312A and 312B are used in adjusting parameters (e.g. depth, magnitude) of the effects applied on the music pieces being played by the media players 2A and 2B, respectively. The channel faders 313A and 313B are used in adjusting output sound volume levels of the music pieces being played by the media players 2A and 2B, respectively.

The cross fader 314 is an operator for adjusting a sound volume balance between a first music piece played by the media player 2A (first channel) and a second music piece played by the media player 2B (second channel).

The mixing curve adjuster knobs 315 are provided by three knobs. The mixing curve adjuster knobs 315 are used in order to set a mixing curve that defines a relationship between an action position of the cross fader 314, which adjusts the sound volume balance between the first and second music pieces, and the sound volume balance described above. In the present exemplary embodiment, the mixing curve adjuster knobs 315, which are used in order to set the mixing curve defining the relationship between the action position of the cross fader 314 and the above-described sound volume balance, are a part of a later-described mixing curve setting unit.

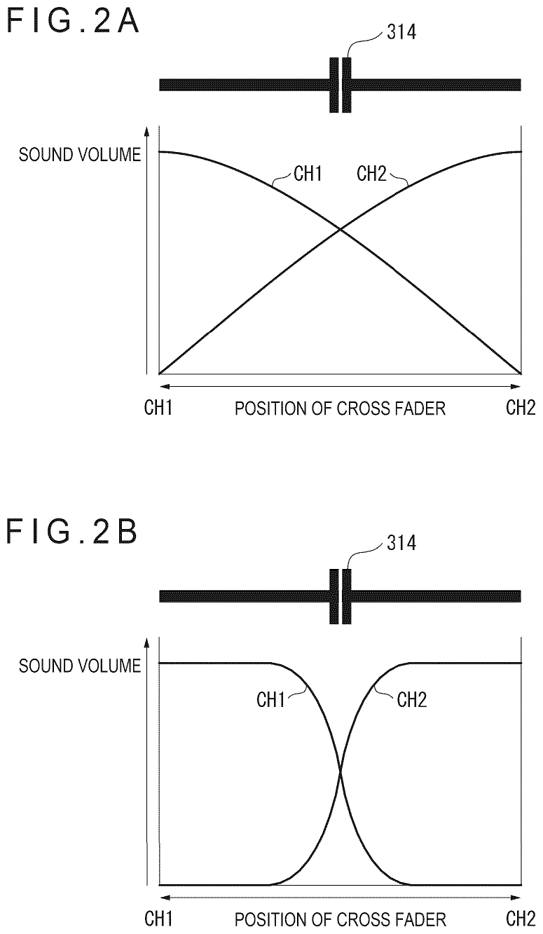

FIGS. 2A and 2B show examples of the mixing curve that are set by the mixing curve adjuster knobs 315. FIG. 2A shows a mixing curve, where the above-described sound volume balance gradually changes. With such a mixing curve set on the cross fader 314 by the mixing curve adjuster knobs 315, when the action position of the cross fader 314 is shifted from left to right or right to left, the music pieces can be switched while gradually changing the above-described sound volume balance (so-called “fade-in and fade-out”).

In contrast, FIG. 2B shows a mixing curve, where the above-described sound volume balance sharply changes. With such a mixing curve set on the cross fader 314 by the mixing curve adjuster knobs 315, when the action position of the cross fader 314 is shifted from left to right or right to left, the music pieces are switched while sharply changing the above-described sound volume balance at rising and falling points of the mixing curve to provide an impression similar to so-called “cut-in and cut-out”. It should be noted that the rising and falling points of the mixing curve in FIG. 2B correspond to a cut-in timing and a cut-out timing, respectively. Details of the setting of the mixing curve by the mixing curve adjuster knobs 315 will be described later.

It should be noted that the operation units 21A, 21B and the operation unit 31 optionally further include a touch panel for detecting a touch position by a user and the like components in addition to the above.

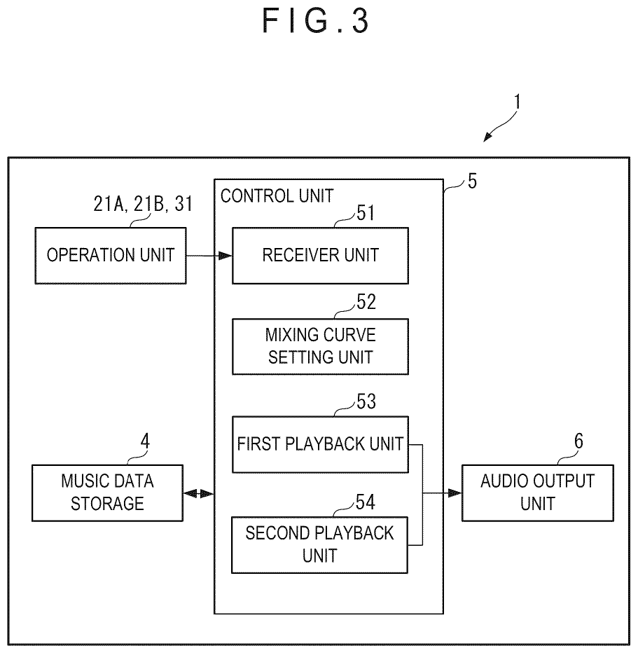

FIG. 3 is a block diagram showing an overall functional arrangement of a processing unit of the acoustic device according to the first exemplary embodiment.

As shown in FIG. 3, the acoustic device 1 includes a music data storage 4, a control unit 5, and an audio output unit 6 in addition to the above-described units. The functions of the above units are implemented by, for instance, arranging the acoustic device configured as a computer hardware and operating a processor of the acoustic device in accordance with a computer program. The functions of the above units will be further described below.

The music data storage 4, which is provided by an HDD (Hard Disk Drive), flash memory, or the like, is capable of storing music data. Specifically, the music data storage 4 stores music data of a plurality of music pieces in a predetermined format (e.g. MP3 format). The music data includes, in addition to audio information, information on BPM, art work, title, artist name, album title, key, the number of DJ performance, genre, and the like of the music pieces in a form of tag information. The music data stored in the music data storage 4 is associated with a time stamp representing information on playback position.

In the present exemplary embodiment, the music data stored in the music data storage 4 in a manner capable of being played by the acoustic device 1 has been subjected in advance to a part-separation processing into a plurality of parts. In the present exemplary embodiment, the plurality of parts separated from the music data each correspond to the sound of corresponding one of the parts of the music piece to be played based on the music data. The parts of the music piece herein correspond to, for instance, a vocal sound and/or sounds of various musical instruments. In a simple example, the music piece is constructed by four parts of the vocal, guitar, bass guitar, and drum. It is also useful to further subdivide the parts into minor categories (sub-parts) per type of the musical instruments: for instance, the drum part is subdivided into bass drum part, snare drum part, and hi-hat drum part. In this case, the music data that is a separation target is optionally directly subjected to part-separation processing into the parts including the bass drum part, snare drum part, and hi-hat drum part. Alternatively, the drum part is optionally separated from the music data and then further subdivided into corresponding sub-parts to perform the part-separation processing in stages. In either case, the parts of the music piece herein include parts further subdivided from the parts of the music pieces: for instance, the parts of the music piece include some parts subdivided from the parts for specific musical instruments in the parts of the music piece. Detailed description of the part-separation processing into the plurality of parts will be omitted herein since the part-separation processing can be performed using various known techniques.

In an example described below, it is supposed that the music data, which has been subjected to the part-separation processing to be separated into three parts (the vocal sound part, the drum sound part, and the bass sound part), is stored in the music data storage 4. It should be noted that the bass sound part refers to a part obtained by removing the vocal sound part and the drum sound part from the entire music data. It should also be noted that the acoustic device 1 is optionally configured to acquire the music data having been subjected to the part-separation processing from an external device or, alternatively, is further provided with a functional component for separating non-separated music data into the plurality of parts. Further alternatively, it is possible that the music data having been subjected to the part-separation processing is used only in a section for the music pieces to be switched and non-separated music data is used in other sections.

The control unit 5, which is implemented in the acoustic device 1 in a form of, for instance, a communication interface, a processor (e.g. CPU (Central Processing Unit)), and a memory providing a working area, controls the operation of the acoustic device 1. The control unit 5 includes a receiver unit 51, a mixing curve setting unit 52, a first playback unit 53, and a second playback unit 54, which are implemented by the processor that works in accordance with a program stored in the memory or received through the communication interface.

The receiver unit 51 is configured to detect a user's operation on the operation units 21A, 21B and the operation unit 31 to receive the user's operation. The receiver unit 51 supplies the information indicating the content of the user's operation to components in the control unit 5.

The mixing curve setting unit 52, in which a plurality of mixing curves of different curve forms are stored in advance, is configured to set one of the mixing curves on the plurality of parts of the music data in accordance with the position of the cross fader 314 in response to the user's operation on the mixing curve adjuster knobs 315.

It should be noted that the mixing curve is optionally set by, for instance, assigning each of the above-described vocal sound part, drum sound part, and bass sound part to the corresponding one of the three knobs of the mixing curve adjuster knobs 315 and designating curvatures of the mixing curves in accordance with operation amounts of the respective mixing curve adjuster knobs 315, or by other method(s). For instance, the mixing curve is optionally set by selecting, for each of the plurality of parts of the music data, one of the plurality of mixing curves stored in advance. In this case, an operator of the acoustic device 1 for setting the mixing curve optionally includes a display for displaying a pattern of the mixing curve and a touch panel or button for receiving selection operation for the pattern.

Further, the mixing curve is optionally set not by directly selecting the mixing curve but by designating, for each of the plurality of parts of the music data, the switching results of the music pieces achieved by selecting the mixing curve. The switching results of the music piece include, for instance, a timing for switching the music pieces by fade-in and fade-out, a time after the music piece after the switching by fade-in and fade-out starts being heard until the music piece before the switching by fade-in and fade-out is not heard, a sound volume of each of the music pieces at a midpoint (where the sound volume becomes even) of fade-in and fade-out, a timing for switching the music pieces by cut-in and cut-out, and a time from the cut-in of the music piece after the switching to the cut-out of the music piece before the switching.

In setting the mixing curve, the music pieces can be switched in accordance with the characteristics of the target music data by designating the above-described switching results on the music data (a target of switching operation) in association with cue point(s) or the like. Such a detailed setting is optionally made before DJ performance using, for instance, the display and the touch panel provided on the acoustic device 1 or a computer connected to the acoustic device 1.

The mixing curve setting unit 52 is configured to set mixing curves of different curves on all of the plurality of parts or set the same mixing curve on two or more of the plurality of parts.

The first playback unit 53 is configured to play the music piece with the media player 2A in response to the user's operation on the operation unit 21A and operation unit 31 and to output audio signals to the audio output unit 6. Similarly, the second playback unit 54 is configured to play the music piece with the media player 2B in response to the user's operation on the operation unit 21B and operation unit 31 and to output audio signals to the audio output unit 6. It should be noted that, when the cross fader 314 is operated, the first playback unit 53 and the second playback unit 54 adjust the sound volume balance between the first and second music pieces per each of the plurality of parts of the first and second music pieces in accordance with the mixing curve(s) set by the mixing curve setting unit 52, thereby switching and playing the music pieces on the media players 2A and 2B.

It should be noted that the acoustic device 1 optionally includes a communication interface (not illustrated), through which music data stored in an external storage, a computer, or the like is imported and stored in the music data storage 4. In this case, the acoustic device 1 does not include the music data storage 4 but the external storage serves as the music data storage 4.

The audio output unit 6, which includes an audio output terminal such as speaker terminal or headphone terminal, outputs audio signals (audio information) of the music pieces have been played by the first playback unit 53 and the second playback unit 54.

Operations of the control unit 5 of the acoustic device 1 when the music pieces are switched by the above-described cross fader 314 will be described below.

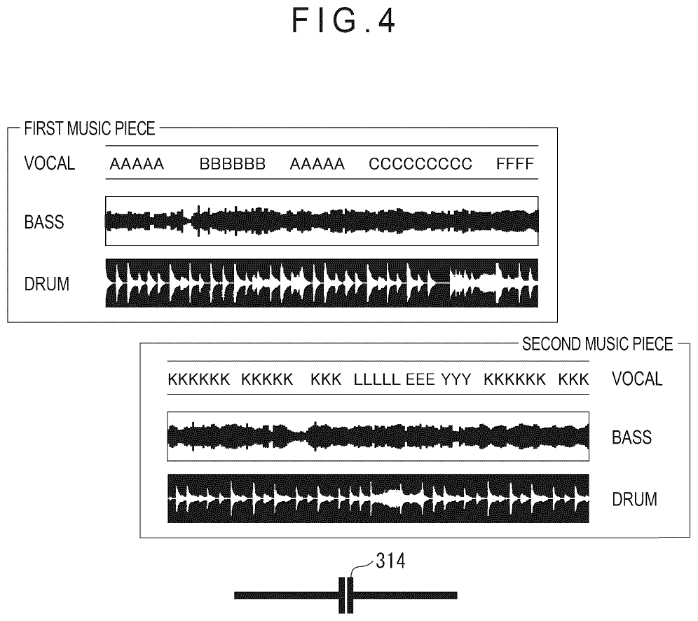

FIG. 4 illustrates an example of a first music data (the first music piece) and a second music data (the second music piece) at a section for the music pieces to be switched by the acoustic device according to the first exemplary embodiment.

Typically, a single mixing curve for entire sounds of the music piece is set on the cross fader in order to switch the music pieces. Accordingly, when a mixing curve for gradually changing the sound volume balance is set on the cross fader and the music pieces are switched by fade-in and fade-out, for instance, the drum sounds of the first and second music pieces are overlapped at a part of sections, where the drum sounds at the time of the switching operation sometimes make uncomfortable and unpleasant impression on a user if peaks of the drum sounds are different due to difference in BPM and/or drum pattern between the first and second music pieces.

When a mixing curve with sharply changing sound volume balance is set on the cross fader and the music pieces are switched by cut-in and cut-out, the entirety of the music piece suddenly changes to make an abrupt impression on a user.

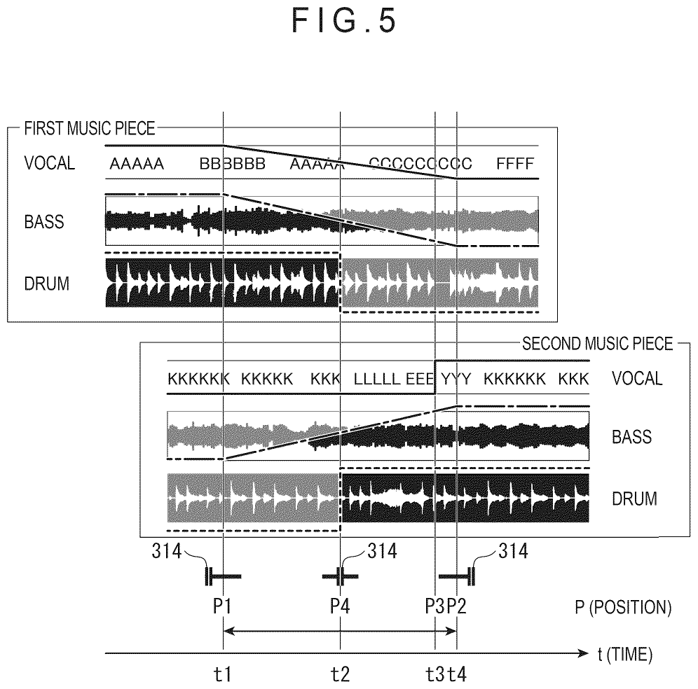

FIG. 5 is an illustration schematically showing a switching process of music pieces by the acoustic device according to the first exemplary embodiment. In an example described below, it is exemplarily assumed that the music piece played by the media player 2A is switched to the music piece played by the media player 2B.

In the example shown in FIG. 5, the following mixing curves are set on respective parts.

Vocal sound part: the first music piece—fade-out; the second music piece—cut-in

Bass sound part: the first music piece—fade-out; the second music piece—fade-in

Drum sound part: the first music piece—cut-out; the second music piece—cut-in

The vocal sound part, which is likely to be perceived by listeners to have continuity due to the presence of melody and lyrics, sometimes makes an abrupt impression on a user when the music pieces are switched by cut-in and cut-out. Accordingly, as for the vocal sound part in the above-described example, the start of the vocal sound part of the second music piece can be vividly highlighted while reducing uncomfortable impression by fading out the vocal sound part of the first music piece and cutting in the vocal sound part of the second music piece at a timing when the sound volume of the vocal sound part of the first music piece is sufficiently diminished.

The mixing curve for the vocal sound part is set so that the first music piece fades out from an action position P1 corresponding to one end of the cross fader 314 to an action position P2 corresponding to the other end of the cross fader 314 and the second music piece cuts in at an action position P3 closer to the action position P1 with respect to the action position P2. It should be noted that, when the vocal sound part of the second music piece is to cut in, depending on a user's operation, the action position of the cross fader 314 possibly deviates from the time on the music data at which the vocal sound part should cut in. Accordingly, a cue point is optionally set in advance for the vocal sound part of the second music piece to cut in, and the vocal sound part of the second music piece optionally cuts in at the cue point near the action position P3. Alternatively, for instance, through known music analysis processing (e.g. vocal detection, lyric displaying), the vocal sound part of the second music piece is optionally made to cut in at a point near the action position P3 at a timing suitable for the vocal sound part to cut in (e.g. interval between words of lyrics and start of the vocal).

The bass sound part, which is likely to be perceived by listeners to have continuity due to the presence of melody (bass line) and lyrics, sometimes makes an abrupt impression on a user when the music pieces are switched by cut-in and cut-out. On the other hand, since the bass sound part has no lyrics, uncomfortable impression as in the vocal sound part is often not roused even when the first and second music pieces are overlapped to be heard as long as, for instance, the keys of the first and second music pieces are the same or compatible with each other. Thus, the bass sound part of the music pieces can be naturally switched without making uncomfortable impression, by fade-out of the first music piece and fade-in of the second music piece. Further, without application of cutting in and cutting out, the bass sound part can be expected to be kept from being silent when the music pieces are to be switched.

The mixing curve for the bass sound part is set so that the first music piece fades out and the second music piece fades in from the action position P1 to the action position P2.

The drum sound part has a large sound volume level, different patterns for each of music pieces, and different delays for each of music pieces from attack sounds to peak sounds (especially for the bass drum). Accordingly, when the drum sound part of the music pieces are switched by fade-in and fade-out, it sometimes occurs that uncomfortable and unpleasant impression is made on the user as described above. On the other hand, since the drum sound part has no melody and lyrics, continuity of the drum sound is unlikely to be perceived by listeners. Thus, the drum sound part of the music pieces can be switched with reduced uncomfortable impression by cutting out the first music piece and cutting in the second music piece.

The mixing curve for the drum sound part is set so that the first music piece cuts out and the second music piece cuts in at an action position P4 between the action position P1 and the action position P2. It should be noted that, when the second music piece cuts in, the drum sound possibly overlaps or cuts in/out in an unnatural rhythm depending on the timing of the drum sound of the first music piece and the second music piece. Accordingly, when the drum sound part of the second music piece cuts in, the drum sound parts can be more naturally switched by starting the playback of the drum sound of the second music piece from an appropriate position, which is determined by detecting beat position, bar position, attack sound of the drum sound part, and/or the like.

With reference again to FIG. 5, when the cross fader 314 starts being operated at a time t1 while a music piece is being played by the media player 2A, the control unit 5 controls the sound volume balance of the parts of each of the first music piece being played by the media player 2A and the second music piece to be played next by the media player 2B in accordance with the mixing curve set by the mixing curve setting unit 52. The first playback unit 53 gradually lowers the sound volumes of the vocal sound part and bass sound part of the first music piece. The second playback unit 54 gradually increases the sound volume of the bass sound part of the second music piece.

At a time t2, when the cross fader 314 is shifted to the action position P4, the drum sound part of the first music piece is made to cut out by the first playback unit 53 and the drum sound part of the second music piece is made to cut in by the second playback unit 54. At this time, the second playback unit 54 optionally makes the drum sound part cut in after a predetermined time elapses since the cross fader 314 is shifted to the action position P4 as described above.

At a time t3, when the cross fader 314 is shifted to the action position P3, the vocal sound part of the second music piece is made to cut in by the second playback unit 54. At this time, the vocal sound part of the second music piece is optionally made to cut in by the second playback unit 54 at the predetermined cue point as described above or alternatively at a timing near the time t3 suitable for the vocal sound part to cut in (e.g. at a predetermined cue point, and interval between words of lyrics or start of the vocal detected through known music analysis processing (e.g. vocal detection, lyrics displaying)).

At a time t4, the cross fader 314 is shifted to the action position P2, whereby the switching process of the music pieces ends.

As described above, when a user operates the cross fader 314 at the time of switching the music piece played by the media player 2A to the music piece played by the media player 2B, the vocal sound parts of the music pieces are switched by fade-out and cut-in, the bass sound parts of the music pieces are switched by fade-out and fade-in, and the drum sound parts of the music pieces are switched by cut-out and cut-in. In other words, a suitable mixing curve is set on each of the parts of the music pieces in advance, so that favorable switching operation can be achieved only by operating the cross fader 314 by a user. In particular, with a simple operation, it is possible to switch the music pieces naturally based on the characteristics of each part of the music pieces and to switch the music pieces with enhanced dramatic effects.

It should be noted that the mixing curves illustrated in the example of FIG. 5 are merely exemplary and are not exhaustive. For instance, though different mixing curves are set on the respective parts in the example illustrated in FIG. 5, the same mixing curve may be set on two or more parts. Further, though mixing curves with different cut-in and cut-out timings are set on the vocal sound part and the drum sound part in the example illustrated in FIG. 5, a mixing curve with the same cut-in and cut-out timing may be set.

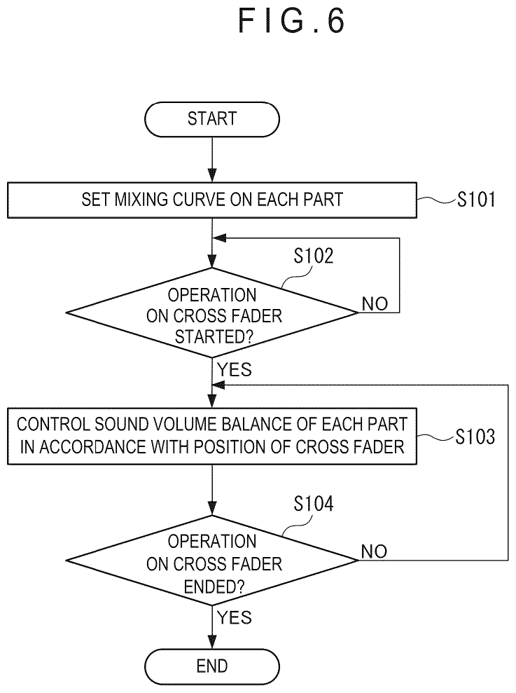

Next, a control method of the acoustic device according to the first exemplary embodiment will be described below with reference to a flowchart illustrated in FIG. 6.

FIG. 6 illustrates a flowchart of a process started when the receiver unit 51 receives an operation on the mixing curve adjuster knobs 315.

Initially, the mixing curve is set on each of the plurality of parts of the first music piece and the second music piece by the mixing curve setting unit 52 (Step S101).

Then, when the cross fader 314 is operated (Step S102: YES), the first playback unit 53 and the second playback unit 54 play respective music pieces of the media player 2A and media player 2B by controlling the sound volume balance of each of the parts of the first and second music pieces in accordance with the action position of the cross fader 314 and the mixing curve set by the mixing curve setting unit 52 (Step S103).

The first playback unit 53 and the second playback unit 54 continue the process of Step S103 until the end of the operation on the cross fader 314 (Step S104: YES).

It should be noted that, though the music pieces are switched from the media player 2A to the media player 2B in the example of FIGS. 5 and 6, the same process is performed in switching the music piece played by the media player 2B to the music piece played by the media player 2A.

According to the first exemplary embodiment of the invention as described above, the acoustic device, which includes the cross fader for adjusting the sound volume balance between the first music piece played through the first channel and the sound volume of the second music piece played through the second channel, sets the mixing curve for each of a plurality of parts of the first music piece and the second music piece in accordance with the position of the cross fader and control the sound volume balance of each of the plurality of parts in accordance with the set mixing curve. Accordingly, each of the plurality of parts of the music pieces can be assigned with a mixing curve in accordance with the characteristics thereof. Further, knowledge and experience related to music are not necessary in selecting the music pieces before and after the switching operation. In addition, even a user with insufficient knowledge and experience on music can easily perform suitable switching operation in switching the music pieces. Accordingly, even a user with insufficient knowledge and experience can enjoy DJ play that accompanies switching operation of the music pieces.

Further, according to the first exemplary embodiment of the invention, the plurality of parts include sub-parts subdivided from the parts of the first music piece and the second music piece. Accordingly, a mixing curve in accordance with the characteristics of the parts can be set in accordance with the details of each of the parts.

Further, according to the first exemplary embodiment of the invention, the plurality of parts include the drum sound part at least corresponding to the bass drum sound. Accordingly, the drum sound parts of the music pieces, which are likely to make uncomfortable and unpleasant impression on a user, can be switched with reference to the characteristics thereof. It is useful to separate the drum sound part into bass drum, snare drum, and hi-hat drum from the drum sound part and switch the music pieces in accordance with the characteristics of the bass drum, snare drum, and hi-hat drum. It is especially useful to separate the bass drum sound part from the drum sound part and switch the music pieces in accordance with the characteristics of the bass drum sound part.

Further, according to the first exemplary embodiment of the invention, the first mixing curve is set on the first part of the plurality of parts and the second mixing curve different from the first mixing curve is set on the second part different from the first part. Accordingly, each of the plurality of parts of the music piece can be switched at a timing and through a process in accordance with the characteristics of each part.

Further, according to the first exemplary embodiment of the invention, the first mixing curve is a curve whose sound volume balance gradually changes and the second mixing curve is a curve whose sound volume balance sharply changes. Accordingly, a suitable switching process of music pieces can be set on each of the plurality of parts of the music piece.

Further, according to the first exemplary embodiment of the invention, the first mixing curve or the second mixing curve is a curve showing that the sound volume of one of the first and second music pieces gradually changes and the sound volume of the other of the first and second music pieces sharply changes. Accordingly, a suitable switching process of music pieces can be set on each of the plurality of parts of the music piece.

It should be noted that the operators described in the first exemplary embodiment are merely exemplary and are not limited to those described in the present exemplary embodiment. For instance, the invention is also applicable to an instance using, instead of the cross fader 314, the channel faders 313A and 313B to switch the music pieces. Alternatively, for instance, the same function as the function described for the cross fader 314 is optionally assigned to existing operator(s) on the acoustic device 1 or a dedicated operator other than the cross fader 314 assigned with the same function as the cross fader 314 is optionally provided on the acoustic device 1.

Further, the invention is not limited to an operator such as the cross fader 314 but is also applicable to an operator provided by software in a form of GUI (Graphical User Interface) or the like. In addition, the invention is also applicable in programmatically switching (cross-fading) the music pieces without requiring an operator (e.g. an automatic mixing process).

### Second Exemplary Embodiment

A second exemplary embodiment will be described below, where components different from those of the first exemplary embodiment will be solely described, omitting the description for the same components as those of the first exemplary embodiment.

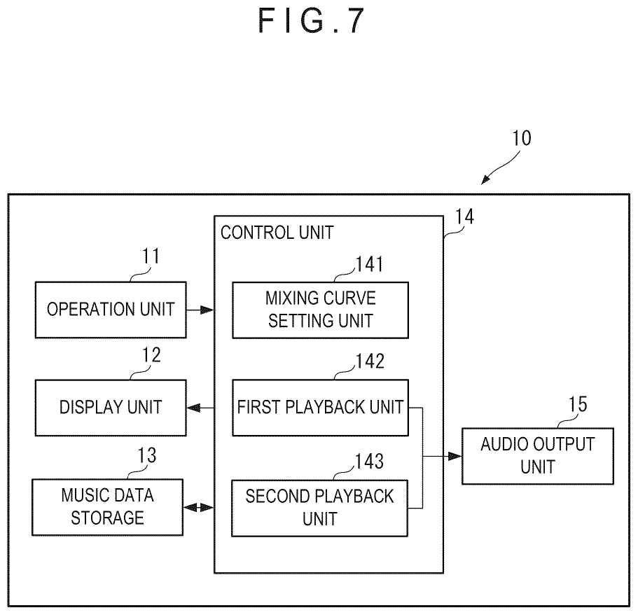

FIG. 7 is a block diagram illustrating an overall functional arrangement of an acoustic device according to the second exemplary embodiment. An acoustic device 10 according to the second exemplary embodiment is a combination of a computer for running a DJ application, a smartphone, and a tablet terminal.

The acoustic device 10 includes an operation unit 11, a display unit 12, a music data storage 13, a control unit 14, and an audio output unit 15. The functions of the above units are implemented by, for instance, arranging the acoustic device 10 configured as a computer hardware and operating a processor of the acoustic device in accordance with a computer program. The functions of the above units will be further described below.

The operation unit 11, which includes a keyboard, a touch panel, and the like, is configured to receive the user's operation in the same manner as the operation units 21A, 21B and the operation unit 31 of the first exemplary embodiment. The display unit 12 includes a display. Since the music data storage 13 is the same as the music data storage 4 in the first exemplary embodiment, the description of the music data storage 13 will be omitted.

As in the first exemplary embodiment, the control unit 14 includes a mixing curve setting unit 141, a first playback unit 142, and a second playback unit 143, which are implemented by the processor that works in accordance with a program stored in the memory or received through the communication interface.

The mixing curve setting unit 141 sets the mixing curve to each of the plurality of parts of the music data. It should be noted that the mixing curve setting unit 52 of the first exemplary embodiment exemplarily sets the mixing curve showing a relationship between the action position of the cross fader 314 and the sound volume balance between the first music piece and the second music piece. However, the mixing curve setting unit 141 of the present exemplary embodiment sets a mixing curve showing a relationship between the sound volume balance and a point for adjusting the sound volume balance between the first music piece and the second music piece for each of the plurality of parts of the music data. The point for adjusting the sound volume balance between the first music piece and the second music piece in the present exemplary embodiment means, for instance, a point (time) in an automatic mixing process for automatically switching the music pieces. The features of the mixing curve are the same as those of the mixing curves described in the first exemplary embodiment.

As in the first exemplary embodiment, the mixing curve is optionally set by the mixing curve setting unit 141 by selecting, for each of the plurality of parts of the music data, one of mixing curves from the plurality of mixing curves stored in advance. Also as in the first exemplary embodiment, the mixing curve is optionally set not by directly selecting the mixing curve but by designating, for each of the parts of the music data, the results of the switching operation on the music pieces achieved by selecting the mixing curve.

The function and structure of the first playback unit 142 and the second playback unit 143 are the same as those of the first playback unit 53 and the second playback unit 54 of the first exemplary embodiment, respectively.

The audio output unit 15, which includes an audio output terminal such as speaker terminal or headphone terminal, outputs audio signals (audio information) of the music pieces have been played by the first playback unit 142 and the second playback unit 143.

It should be noted that the acoustic device 10 optionally includes a communication interface (not illustrated), through which music data stored in an external storage, a computer, or the like is imported and stored in the music data storage 13. In this case, the acoustic device 10 does not include the music data storage 13 but the external storage serves as the music data storage 13.

Further, at least a part of the functions of the acoustic device 10 is optionally separated and implemented by a server (e.g. a cloud server) connected in a manner capable of communication through the Internet network and/or wireless network.

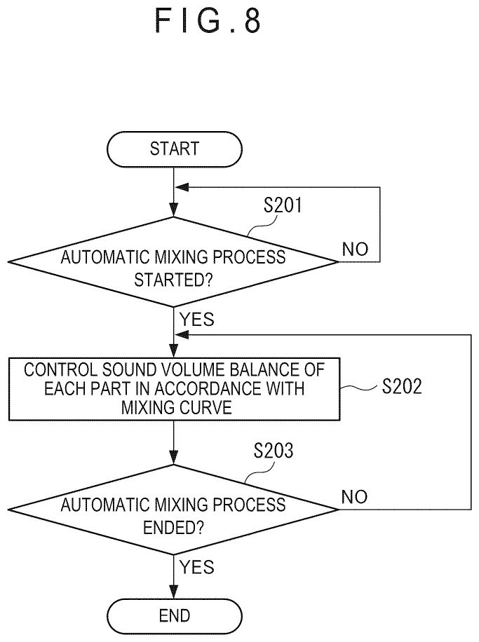

Next, a control method of the acoustic device according to the second exemplary embodiment will be described below with reference to a flowchart illustrated in FIG. 8.

FIG. 8 illustrates a flowchart of a process started upon receiving an instruction for starting the automatic mixing process. According to the automatic mixing process, the mixing curve setting unit 141 sets in advance a mixing curve on each of the plurality of parts of the first music piece and the second music piece.

When the automatic mixing process is started (Step S201: YES), the first playback unit 142 and the second playback unit 143 play respective music pieces of the media player 2A and media player 2B by controlling the sound volume balance of each of the parts of the first and second music pieces in accordance with the mixing curve set by the mixing curve setting unit 141 (Step S202).

The first playback unit 142 and the second playback unit 143 continue the process of Step S202 until the end of the automatic mixing process (Step S203: YES).

According to the second exemplary embodiment of the invention as described above, the advantages as those in the first exemplary embodiment can also be achieved by an acoustic device having no cross fader component. Especially, by the automatic mixing process, the timing for cutting in/out and the like can be easily set in detail and the music pieces can be more freely switched by, for instance, adjusting the tempo (BPM) of the second music piece in accordance with a difference in tempos (BPM) between the first and second music pieces.

It should be noted that the plurality of parts of the first music piece and the second music piece, which are exemplified by three parts (i.e. the vocal sound part, drum sound part, and bass sound part) in the above exemplary embodiments, are merely exemplary and are not limited by the description of the exemplary embodiments. For instance, a part other than the above-mentioned three parts (e.g. piano sound part) may be subjected to the same process.

The mixing curves described in the exemplary embodiments are merely exemplary and are not limited to those described in the exemplary embodiments. For instance, a bilaterally asymmetric mixing curve or the like is also usable.

The acoustic device with the above functions is not necessarily configured as in the example described in the exemplary embodiments but is optionally provided in a form of, for instance, a mixer and a DJ controller with a mixer function in some embodiments. Further, the invention is applicable not only to a DJ instrument and DJ application but also to a streaming service using music application software and/or the Internet and the like. In this case, the invention is applicable to, for instance, an automatic playback using a playlist or the like.

A 2-channel acoustic device including two media players 2A and 2B is described in the above exemplary embodiments. However, for instance, a 4-channel acoustic device can also achieve the same functions. In addition, the invention is applicable not only to a DJ instrument but also to a typical mixer, electronic music instrument, and acoustic device such as DAW (Digital Audio Workstation) and DTM (Desk Top Music).

Suitable exemplary embodiments of the invention have been detailed above with reference to the attached drawings. However, the scope of the invention is not limited to the exemplary embodiments. It would be obvious for those skilled in the art to which the invention pertains that various modifications and revisions are conceivable within the technical idea described within claims, and it is understood that such modifications and revisions are naturally within the technical scope of the invention.

### EXPLANATION OF CODES

1, 10 . . . acoustic device, 2A, 2B . . . media player, 3 . . . mixer, 4, 13 . . . music data storage, 5, 14 . . . control unit, 6, 15 . . . audio output unit, 11, 21A, 21B, 31 . . . operation unit, 51 . . . receiver unit, 52, 141 . . . mixing curve setting unit, 53, 142 . . . first playback unit, 54, 143 . . . second playback unit, 211A, 211B . . . jog dial, 212A, 212B . . . tempo slider, 213A, 213B . . . cue button, 214A, 214B . . . play/pause button, 215A, 215B . . . performance pad, 311A, 311B . . . effect selector knob, 312A, 312B . . . effect amount adjuster knob, 313A, 313B . . . channel fader, 314 . . . cross fader, 315 . . . mixing curve adjuster knobs

1. An acoustic device comprising:
a cross fader configured to adjust a sound volume balance between a first music piece played through a first channel and a second music piece played through a second channel;
a setting unit configured to set a mixing curve on each of a plurality of parts of the first music piece and the second music piece in accordance with a position of the cross fader; and
a playback controller configured to control the sound volume balance of each of the plurality of parts in accordance with the mixing curve.

2. The acoustic device according to claim 1, wherein the plurality of parts of the first music piece and the second music piece comprise sub-parts subdivided therefrom.

3. The acoustic device according to claim 1, wherein the plurality of parts at least comprise a sub-part corresponding to a bass drum sound of a drum sound.

4. The acoustic device according to claim 1, wherein the setting unit is configured to set a first mixing curve on a first part of the plurality of parts and set a second mixing curve different from the first mixing curve on a second part different from the first part.

5. The acoustic device according to claim 4, wherein the first mixing curve is a curve whose sound volume balance gradually changes and the second mixing curve is a curve whose sound volume balance sharply changes.

6. The acoustic device according to claim 4, wherein the first mixing curve or the second mixing curve is a curve showing that a sound volume of one of the first and second music pieces gradually changes and a sound volume of the other of the first and second music pieces sharply changes.

7. A control method of an acoustic device comprising a cross fader configured to adjust a sound volume balance between a first music piece played through a first channel and a second music piece played through a second channel, the method comprising:
setting a mixing curve on each of a plurality of parts of the first music piece and the second music piece in accordance with a position of the cross fader; and
controlling the sound volume balance of each of the plurality of parts in accordance with the mixing curve.

8. A non-transitory computer-readable recording medium storing a program causing a computer to operate as an acoustic device, the acoustic device comprising:
a cross fader configured to adjust a sound volume balance between a first music piece played through a first channel and a second music piece played through a second channel;
a setting unit configured to set a mixing curve on each of a plurality of parts of the first music piece and the second music piece in accordance with a position of the cross fader; and
a playback controller configured to control the sound volume balance of each of the plurality of parts in accordance with the mixing curve.
